(19) United States
(12) Patent Application Publication
(10) Pub. No.: US 2004/0052341 A1
(43) Pub. Date: Mar. 18, 2004

(54) System for automatic notification of caller ID, e-mail identification and short message

(76) Inventors: I-Hau Yeh, Hsinchu (TW); Hou-Te Lu, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/245,637

(22) Filed: Sep. 18, 2002

(51) Int. Cl. H04M 11/00; H04M 1/64; H04M 3/42

(52) U.S. Cl. 379/88.19; 379/88.13; 709/206

(57) ABSTRACT

A system for automatic notification of caller ID, e-mail identification and short message is disclosed for a user to receive incoming caller ID, short message and e-mail identification from a telephone. The e-mail identification includes some of the profile of an e-mail and is provided by an e-mail identification data server. The system includes a receiver for receiving and decoding the caller ID, short message and e-mail identification. The decoded data is displayed in an output apparatus or is read out by voice. In some applications, the receiver can be integrated to the current electronic apparatus, such as television, computer, personal digital assistant, electronic dictionary, electronic watch, etc.

### FIELD OF THE INVENTION

The present invention relates generally to an information service system, and more particularly, to a system for automatic notification of caller ID (CID), e-mail identification (EID) and short message.

### DESCRIPTION OF RELATED ART

Telephone systems are popular for communications. People may communicate with each other real time by telephone network. Recently, caller ID display has been developed for the telephone system and thus the called party may judge who is the caller and then determines whether or not to response to the phone call. Moreover, the caller ID can be recorded so that users may know the calling party by checking the recorded caller ID. This is beneficial for reducing the loss of calling. Many telephone systems in Europe, America and Asia have been introduced the function of caller ID display, and, therefore, more and more telephone are appended with this function.

In other aspect, short messages and e-mails provide further approaches for communications. Applications of short messages are popular between mobile phones. Currently, the contents transferred by short messages include texts, drawings, cartoons, music, etc.

With the development of networks, e-mails have become another popular way for communications. To acquire newest e-mails, the user needs to keep connected to the network or log on the network again and again to contact the e-mail server in the network. However, this will induce the waste of network resource since the e-mails are in fact not coming for each second. Furthermore, for users not using leased lines to receive and transmit e-mails, such as those using public switched telephone network (PSTN), a great expense is required for connecting to Internet and communication service.

It is a trend to diversify the communication applications. If caller ID display and short message services can be integrated and the disadvantages of e-mail services can be improved, the users can enjoy a real-time and convenient communication service.

### SUMMARY OF THE INVENTION

Accordingly, one object of the present invention is to provide a system for automatic notification of caller ID, e-mail identification and short message, by which various communication services are integrated.

Another object of the present invention is to integrate other communication services with the current caller ID display system.

According to the present invention, a system for automatic notification of caller ID, e-mail identification and short message enables a user to receive caller ID, short message and e-mail identification that includes some of the profile of an e-mail and is provided by an e-mail identification data server. The system includes a receiver for receiving and decoding the caller ID, short message and e-mail identification and an output apparatus for display or voice output. In some applications, the receiver can be integrated to the current electronic apparatus, such as television (TV), computer, personal digital assistant (PDA), electronic dictionary, electronic watch, etc.

The various objects and advantages of the present invention will be more readily understood from the following detailed description when read in conjunction with the appended drawings.

### BRIEF DESCRIPTION OF THE DRAWINGS

FIG. 1 shows the architecture of the present invention;

FIG. 2 shows one embodiment architecture of the present invention for transferring short message;

FIG. 3 shows another embodiment architecture of the present invention for transferring short message;

FIG. 4 shows a further embodiment architecture of the present invention for transferring short message;

FIG. 5 shows one embodiment architecture of the present invention for transferring e-mail identification;

FIG. 6 shows another embodiment architecture of the present invention for transferring e-mail identification;

FIG. 7 shows a further embodiment architecture of the present invention for transferring e-mail identification; and

FIG. 8 shows one embodiment receiver of the present invention.

### DETAILED DESCRIPTION OF THE INVENTION

The feature of the present invention is to integrate other communication services with the current caller ID display so as to provide a multifunctional communication service.

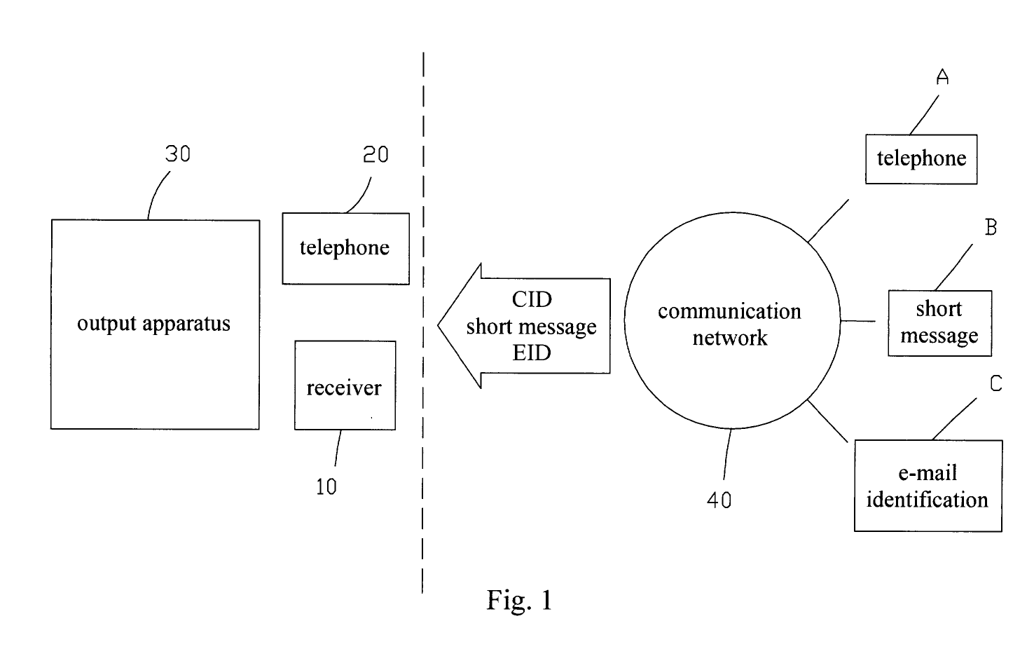

The basic architecture of the present invention is shown in FIG. 1, in which a receiver 10 is located at the telephone side 20 for receiving information, such as caller ID, short message and e-mail identification, transferred to the telephone side 20. This information is further transferred to an output apparatus 30 for display or speech output. The output apparatus 30 can be a display or other electronic apparatus with a display thereof, or an electronic apparatus, which can output speech signals as voices. The user at the telephone side 20 may see the received message or hear the received message by the output apparatus 30. The e-mail identification includes some basic profile of an e-mail, such as the subject of the e-mail, transfer date, e-mail address, name, etc. These summary profiles provide for the user to thereby determine whether or not to surf Internet for receiving the e-mail.

In the appended drawings, the receiver 10, telephone 20 and output apparatus 30 are separately shown in respective block for illustration, while in fact, the receiver 10 may be integrated with the telephone 20 or with the output apparatus 30, or the receiver 10, telephone 20 and output apparatus 30 can be integrated in an apparatus.

The caller ID A, short message B and e-mail identification C are transferred on a communication network 40. The communication network 40 can be serving as a medium for information transmission, or a transfer center for the information. For example, in the current caller ID system the communication network 40 typically includes an exchange system. When the telephone A on the caller end dials to the telephone 20 on the receiver end, the exchange system in the communication network 40 will transfer the basic profile, such as the directory number of the caller, name of the caller, calling time, etc., to the telephone side 20. The receiver 10 (herein, called as a caller ID display) at the telephone side 20 will display these messages on the display. The architecture of a caller ID display is well known by those skilled in the art and thus the details thereof will not be further described herewith.

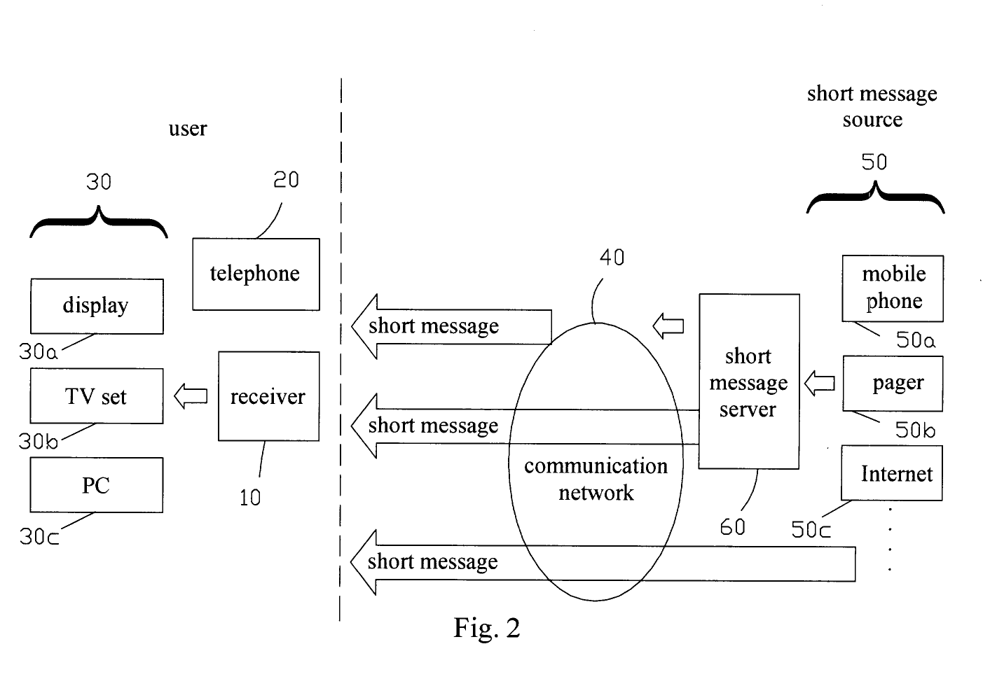

FIG. 2 shows one embodiment architecture for the short message transmission according to the present invention. The short message source 50 includes any source, which can provide short message, such as mobile phone 50a, pager 50b and Internet 50c. The content of the short message may include such as financial message, traffic schedule, advertise message, news, climate report, product scheme, stock message, coupon, etc. The short message may be represented by text, drawing or ringing. The short message source 50 sends short messages to a short message server 60 in wired or wireless transmission, for example, by PSTN, Internet, GSM system, etc. The short message server 60 can be provided by an Internet service provider (ISP), an e-mail service provider or a short message service (SMS) center. Other than the function of transferring short messages, the short message server 60 can be capable of storing short messages to temporarily store received messages when the communication network 40 cannot work.

The ways for transferring short messages from the short message source 50 to the telephone side 20 will be described in the following.

One method is that the short message source 50 directly sends the short message to the telephone side 20 by the communication network 40 when a connection is established between the short message source 50 and the telephone 20.

Another is to transfer the short message provided by the short message source 50 to the short message server 60, and then the short message server 60 transfers the short message to the telephone side 20 by the communication network 40. There are two ways can be used in this method for the short message sever 60 to transfer the short message to the telephone side 20. In one way, the short message server 60 sends the short message to the telephone side 20 after the short message server 60 is connected to the telephone 20 by the communication network 40, and the communication network 40 is only served as a transmission medium. In another way, the short message server 60 sends the short message to an exchange system (not shown) in the communication network 40, and then the exchange system sends the short message to the telephone side 20 after the exchange system is connected to the telephone 20. This manner the communication network 40 is served as a transfer center for the short message.

Transferring short messages by the exchange system in the communication network 40 is under the consideration of current communication networks architecture, however, it is only one embodiment of the present invention and other ways of transferring short messages in the communication network 40 can be adapted to the present invention.

The short message sent to the telephone side 20 is received by the receiver 10 and then-is decoded and/or demodulated for recovering the original signal. Then, the recovered signal is sent to the output apparatus 30. In this embodiment, the output apparatus 30 is a display 30a, a television 30b, a computer 30c, etc. The user can view the incoming messages from the display of the output apparatus 30, or hear the speech output from the television 30b or computer 30c. The display 30a can be, for example, a cathode ray tube (CRT) display, a liquid crystal display (LCD), or a light emitting diode (LED) display and the like. The receiver 10 can be connected with the television 30b or computer 30c by wired or wireless means.

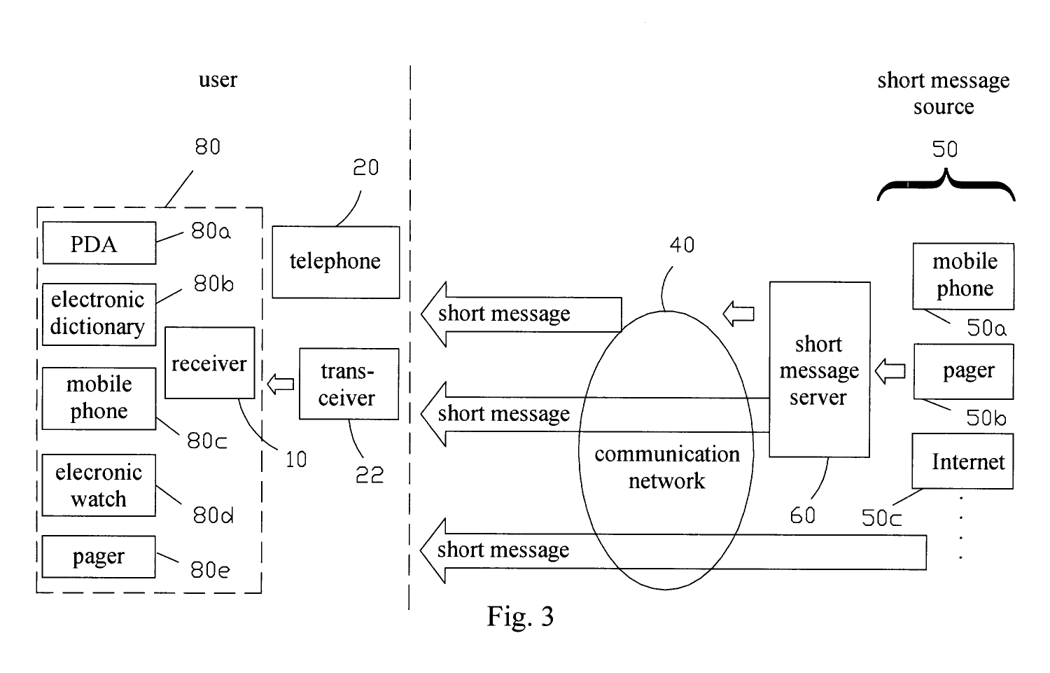

FIG. 3 shows another embodiment architecture of the present invention for short message transfer, which is similarly to that shown in FIG. 2 except that the short message sent to the telephone side 20 is received by a transceiver 22 and then sent to an electronic apparatus 80 having a receiver 10 by wired or wireless means. The electronic apparatus 80 is integrated with the receiver 10 for decoding and/or demodulating the short messages from the transceiver 22 and the output apparatus 30 for display of the short messages or reading out the short messages. Conveniently, the receiver 10 can be integrated into a current electronic apparatus capable of displaying or speech outputting, for example, personal digital assistant 80a, electronic dictionary 80b, mobile phone 80c, electronic watch 80d, pager 80e, etc. It should be understand, in this embodiment, the transceiver 22 is only transmitting the received short message without decoding or recovering the short message.

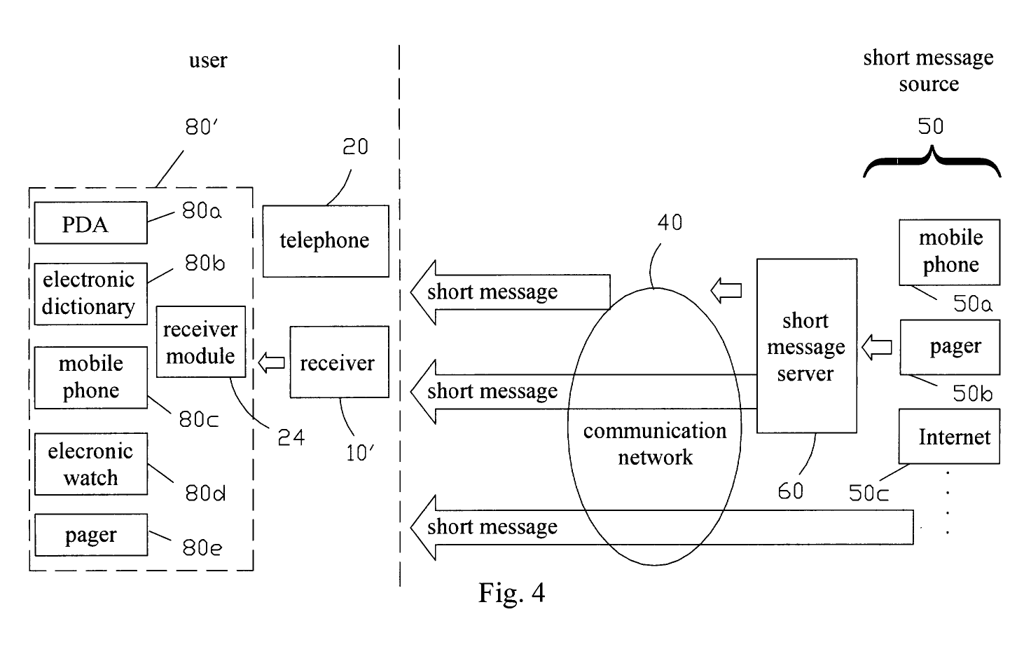

FIG. 4 shows a further embodiment architecture of the present invention for short message transfer, which is different from that shown in FIG. 3 by transceiver 10′. Other than decoding and/or demodulating the short messages, the receiver 10′ has a further function of re-transmitting the recovered short messages. This function can be realized by building a transmitting module in the receiver 10′.

Other than providing an output apparatus 30, the electronic apparatus 80′ further includes a receiver module 24 for receiving the short messages sent by the receiver 10′. Then the short messages are displayed or outputted by speech by the output apparatus 30 provided in the electronic apparatus 80.

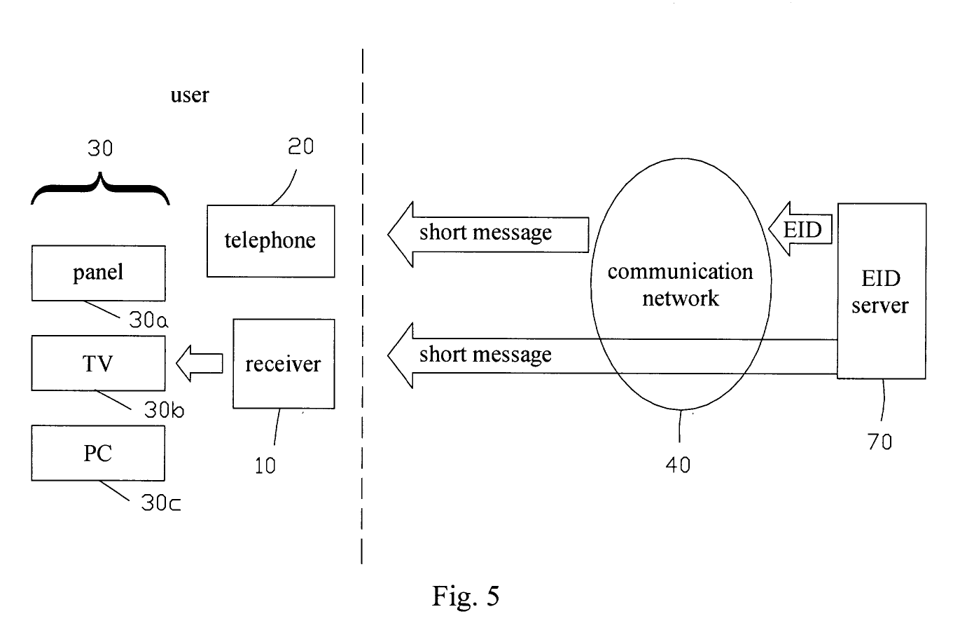

The architecture for transferring the e-mail identification is illustrated in FIG. 5. The e-mail identification data server 70 sends some identification data of the e-mail designated to the user at the telephone side 20, such as the subject of the e-mail, mailing date, e-mail address and name of the mailer, etc., to the telephone side 20 by communication network 40. These identification data can be provided by the mail server and then is sent to the e-mail identification data server 70. The mail server can be provided by an Internet service provider or an e-mail provider. Alternately, the e-mail identification data server 70 is a mail server, which processes the received mails and then gets and transfers the e-mail identification data. In summary, the e-mail identification data server 70 has at least the function of transferring the e-mail identifications. In addition, the e-mail identification data server 70 can be also equipped with the function of storing the e-mail identifications to thereby store the e-mail identification when the communication network 40 does not work.

In the following is described the ways that the e-mail identification data server 70 transfers e-mail identifications to the telephone side 20 by the communication network 40. One of the ways is that the e-mail identification data server 70 sends the e-mail identification to the telephone side 20 after the e-mail identification data server 70 is connected to the telephone 20 by the communication network 40. This manner the communication network 40 is only serving as a transmission medium. In another way, the e-mail identification data server 70 sends the e-mail identification to the exchange system (not shown) of the communication network 40 and then the exchange system transfers the e-mail identification to the telephone side 20 after the exchange system is connected to the telephone 20. This manner the communication network 40 is utilized for re-transmitting the e-mail identifications for the e-mail identification data server 70. However, use of the exchange system in the communication network 40 to transfer the e-mail identifications is only one embodiment of the present invention, while other ways capable to transfer data to the telephone side 20 during the telephone 20 is off hook are also available from the scope of the present invention.

It should be appreciated that according to the present invention, e-mail identifications are provided to the telephone side 20 by the e-mail identification data server 70 actively which is different from that in prior arts by that the user accesses new e-mail by actively connecting to the mail sever on a network by prior arts. Since the e-mail identifications are obtained based on the profiles of e-mails, users may roughly understand the content of the e-mail in advance so as to determine whether receiving the e-mail or doing other processes.

The receiver 10 receives the e-mail identification at the telephone side 20 and then decodes and/or demodulates the e-mail identification, and then transfers the identification data to the output apparatus 30 for display or speech out put. The output apparatus 30 are described in reference to listed in FIG. 2.

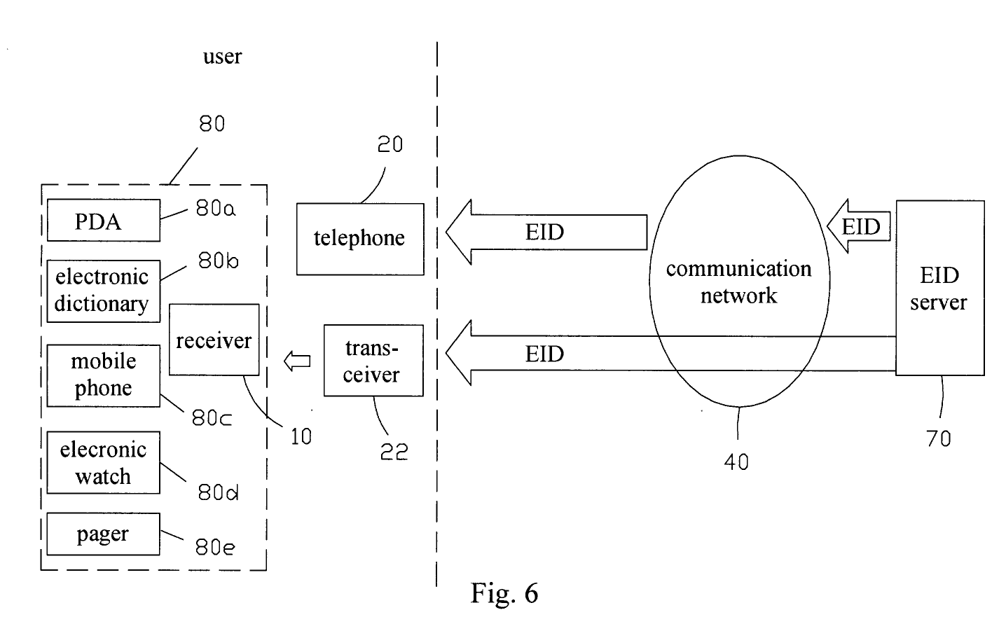

Another embodiment architecture of the present invention for transmission of the e-mail identification is illustrated in FIG. 6, which is similar to that disclosed in FIG. 5 except that the e-mail identifications at the telephone side 20 are received by transceiver 22 and then transferred to electronic apparatus 80, which has a receiver 10, by wired or wireless communication. The transceiver 22 receives and transmits data without decoding or recovering the data. The electronic apparatus 80 includes the receiver 10 and an output apparatus 30 for decoding and recovering the e-mail identification from the transceiver 22 and then the e-mail identifications are outputted by a display or in speech. The receiver 10 can be integrated to an electronic apparatus having an output apparatus 30, such as personal digital assistant 80a, electronic dictionary 80s, mobile phone 80c, electronic watch 80s, pager 80e, etc.

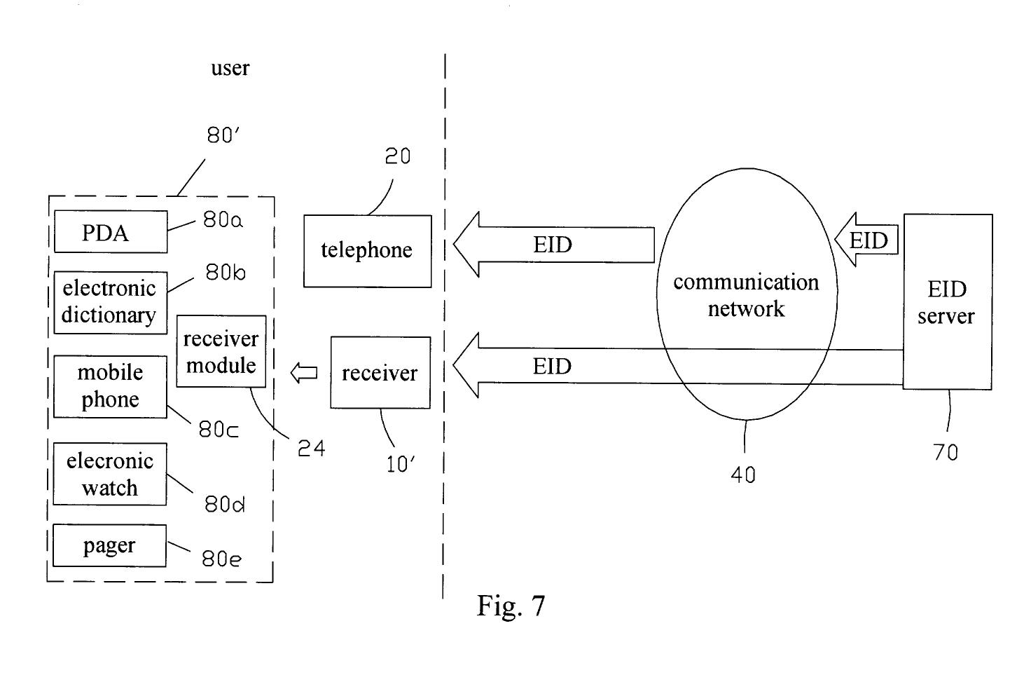

FIG. 7 shows one further embodiment architecture for the e-mail identification transfer according to the present invention, which is different from that shown in FIG. 6 by that the e-mail identification transferred to the telephone side 20 is received by the receiver 10′. Other than decoding and/or demodulating the e-mail identifications, the receiver 10′ has a function of re-transmitting the recovered e-mail identifications. This function can be realized by a built-in transmitter module in the receiver 10′. Except for an output apparatus 30, electronic apparatus 80′ has a receiver module 24 for receiving the e-mail identifications from the receiver 10′. Then, the contents of the e-mail identification are displayed or outputted in speech by the output apparatus 30.

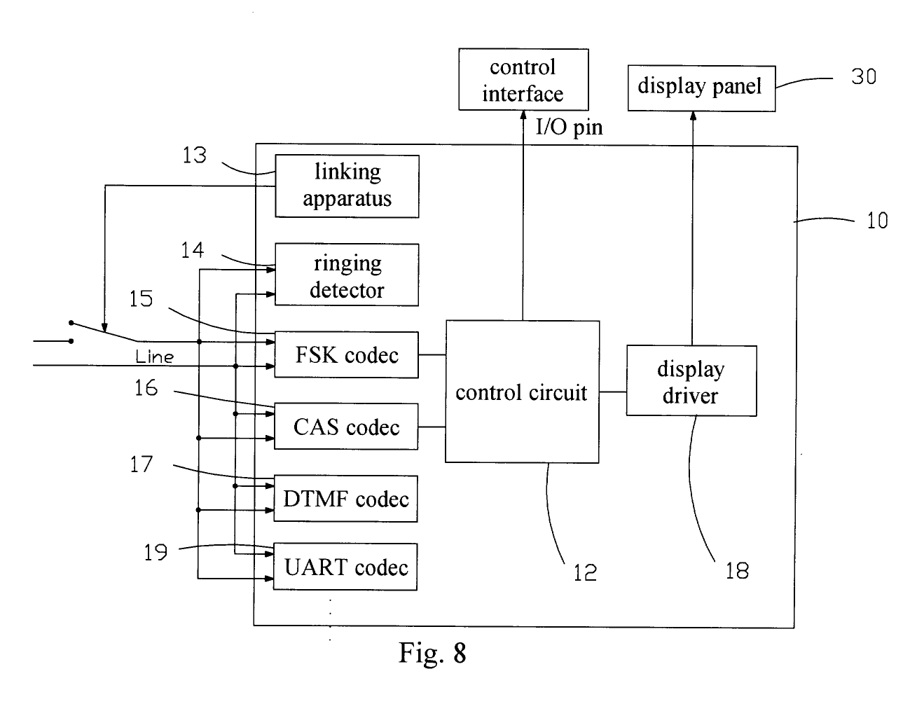

The short messages and e-mail identifications may have different transmission formats, for example, frequency Shift keying (FSK), dual Tone multi-frequency (DTMF), universal asynchronous receiver and transmitter (UART), and customer-premise-equipment alerting signal (CAS). Preferably, the caller ID, e-mail identification and short message have a same transmission format. The receiver 10 at the telephone side 20 has corresponding decoding/demodulating apparatus for processing incoming data. One embodiment of the receiver 10 according to the present invention is illustrated in FIG. 8. The receiver 10 has a control circuit 12 for controlling the process performed by the receiver 10. A ringing detector 14, an FSK codec (encoder/decoder) 15, a CAS codec 16, a DTMF codec 17, and a UART codec 19 are coupled between a line and the control circuit 12. A linking apparatus 13 serves for control of connection of the telephone 20 and the short message server 60 or the e-mail identification data server 70 when the telephone 20 is on-hook. Generally, the receiver 10 has at least one decoder for recovering the incoming data. In this embodiment, an encoder is added for encoding message.

The receiver 10 has a display driver 18 connected to the control circuit so as to drive a display panel 30. In another embodiment, the display panel 30 and receiver 10 can be integrated as a current caller ID display. Moreover, the display panel 30, receiver 10 and telephone 20 can be integrated as a current telephone with caller ID display function. In an alternative embodiment, the display driver 18 can be integrated with the display panel 30. The receiver 10 can be connected to the control interface of an external electronic apparatus by an I/O port of the control circuit 12 to thereby control the external electronic apparatus. In another embodiment, the receiver 10 can further include an informing signal output apparatus (not shown) to inform the user when the caller ID, short message or e-mail identification of the caller are received. The informing signal may be speech signal, ringing signal, music signal, flash, text, symbol, etc. In other aspect, the receiver 10 comprises a speech output apparatus for outputting the received caller ID, short message or e-mail identification by voices.

In various embodiments of the present invention, to display messages on a television or a computer is advantageous since they are popular and frequently used in homes. In an architecture for outputting messages on a television or a computer, the receiver 10 may be an external apparatus out of the television or computer and transfers the decoded and/or demodulated caller ID, short message and e-mail identification to the television or computer by a wired or wireless connection. Alternatively, the receiver 10 can be integrated to a television or computer for receiving and recovering the caller ID, short message or e-mail identification. Then, the data are displayed on the screen of the television or computer or by speech from a speaker in the television or computer. The screen of the television or computer may be a liquid crystal display (LCD), a CRT display or a plasma display panel (PDP).

One aspect of the present invention is to provide diversified communication services, which may be further integrated with the current caller ID display system. The architecture of the present invention provides a new way for receiving messages, for example, the user's phone can be used to receive short messages or e-mail identifications. As for the caller ID display, the short message and e-mail identification may be provided to the user so that the user can determine whether or not to receive the message. Thereby, the time of the user can be saved, the working efficiency is improved, and the user may get the necessary messages. As compared with prior arts, the architecture of the present invention provides diversified and more valuable communication applications.

Another aspect of the present invention is that messages can be outputted by the current electronic apparatus, such as telephone with liquid crystal display, television, and computer. Telephone, television and computer are popular in most homes, and more especially, the television and computer can be used to display the caller ID, short message and e-mail identification when the user is watching TV or uses a computer, hence the contents of the incoming data can be reached immediately.

A further aspect of the present invention is that a wireless transmitter can be equipped at the user end to re-transmit the received caller ID, short message and e-mail identification to a personal portable apparatus, such as watch and personal digital assistant. Thereby, the user may reach the incoming information at any time. This is a convenient way of receiving information.

The above-mentioned embodiments can be combined together, where among the defective entries, some are redirected to the pseudo entries by the method shown in FIG. 3, and the rest of the defective entries are hidden by the method shown in FIG. 1, for instance when the backup register pool 400 is used up, the remaining error entries are directly hidden instead of redirected to pseudo entries.

What is claimed is:

1. A system for automatic notification of caller ID, e-mail identification and short message for a user at a telephone side, the system comprising:
a caller ID provider for providing the caller ID to be transmitted to the user;
a short message source for transferring short message to the user;
an e-mail identification data server for actively transferring the e-mail identification to the user, the e-mail identification including a profile of an e-mail for the user;
a receiver at the telephone side for receiving and decoding the caller ID, short message and e-mail identification; and
an output apparatus for representing the caller ID, short message and e-mail identification to the user by a display or in speech.

2. A system of claim 1, wherein the output apparatus includes a read-out apparatus for a speech output.

3. A system of claim 1, wherein the output apparatus is selected from the group composed of telephone, television, computer, personal digital assistant, electronic dictionary, electronic watch and mobile phone.

4. A system of claim 1, wherein the caller ID includes telephone number, name or calling time of a caller.

5. A system of claim 1, wherein the e-mail identification includes a subject, mailing date, e-mail address or name of a sender of the e-mail.

6. A system of claim 1, wherein the caller ID provider is an exchange system in a communication network.

7. A system of claim 1, further comprising a short message server for receiving and re-transmitting the short message from the short message source to the user.

8. A system of claim 1, wherein the e-mail identification data server is provided by an Internet service provider.

9. A system of claim 7, wherein the short message server is provided by an Internet service provider.

10. A system of claim 1, wherein the e-mail identification data server is provided by an e-mail service provider.

11. A system of claim 7, wherein the short message server is provided by an e-mail service provider.

12. A receiver at a telephone side for receiving and demodulating a caller ID, short message and e-mail identification, the e-mail identification being sent to the telephone side by an e-mail identification data server actively, the e-mail identification being based on a profile of an e-mail, the receiver comprising:
a decoder for decoding the caller ID, short message and e-mail identification; and
a control circuit for processes of the receiver, the control circuit being connected to the decoder and transferring a decoded caller ID, short message and e-mail identification to an output apparatus.

13. A receiver of claim 12, further comprising a speech output apparatus for outputting the decoded caller ID, short message and e-mail identification in voice.

14. A television at a telephone side for automatic notification of caller ID, short message and e-mail identification, the television receiving and displaying the caller ID, short message or e-mail identification, the e-mail identification being sent to the telephone side by an e-mail identification data server actively, the e-mail identification being based on a profile of an e-mail designated to the telephone side, the television being characterized in that: the television includes a decoder for decoding the caller ID, short message or e-mail identification, and sends the caller ID, short message or e-mail identification to a screen of the television.

15. A system for caller ID display and short message transfer service for a user at a wired telephone side, the system comprising:
a caller ID provider for providing the caller ID and transferring the caller ID to the wired telephone side;
a short message server for transferring the short message to the telephone side;
a receiver at the telephone side for decoding the caller ID or short message; and
an output apparatus for displaying the decoded caller ID or short message.

16. A system of claim 15, wherein the output apparatus has a read-out apparatus for speech output.

17. A system of claim 15, wherein the output apparatus is selected from the group composed of telephone with caller ID display function, television, computer, personal digital assistant, electronic dictionary, electronic watch and mobile phones.

18. A system of claim 15, wherein the caller ID provider is an exchange system in a communication network.

19. A system of claim 15, wherein the short message source is selected from the group composed of mobile phone, pager and Internet.

20. A system of claim 15, further comprising a short message server for receiving and transferring the short message from the short message source to the telephone side.

21. A system of claim 20, wherein the short message server is provided by an Internet service provider.

22. A system of claim 20, wherein the short message server is provided by an e-mail service provider.
